(19) United States
(12) Patent Application Publication
(10) Pub. No.: US 2018/0117646 A1
(43) Pub. Date: May 3, 2018

(54) Cleaning Device for Surfaces

(71) Applicant: Fraunhofer-Gesellschaft zur Förderung der angewandten Forschung e.V., Munich (DE)

(72) Inventors: Marc Mauermann, Dresden (DE); Andre Boye, Dresden (DE); Roman Murcek, Dresden (DE)

(21) Appl. No.: 15/785,440

(22) Filed: Oct. 17, 2017

(30) Foreign Application Priority Data
Oct. 28, 2016 (DE) 102016120629.0
Apr. 27, 2017 (DE) 102017109111.4

(51) Int. Cl. B08B 9/093; B08B 9/46; B08B 5/04

(52) U.S. Cl. CPC B08B 9/0936; B08B 5/04; B08B 9/46

(57) ABSTRACT

A cleaning device and a cleaning method for surfaces (22) in an application space (20) comprising at least a removal means (4) for application of a cleaning fluid (7) and/or for the removal of adhesions from the surfaces (22), and at least one positioning means (12) of the cleaning device (1) in the application space (20). According to the invention, the positioning means (12) is connected with a control means (1), which comprises a storage device (1), and with the at least one removal means (4) such that cleaning parameters stored in the storage device of the control means can be assigned to a position, and are transferred by the control means to the removal means (4), and the cleaning parameters, when the position is reached, are applied to the removal means (4).

### CROSS REFERENCE TO RELATED APPLICATIONS

This application claims the priority of DE 102016120629.0 filed on 2016 Oct. 28 and the priority of DE 102017109111.4 filed on 2017 Apr. 27; all applications are incorporated by reference herein in their entirety.

### BACKGROUND

The invention concerns a cleaning device for at least one surface, hereinafter called surfaces, in an application space, in particular for use within closed industrial plants, comprising at least a removal means for applying a cleaning agent and/or for removing adhesions from the surfaces as well as at least a positioning means.

Cleaning is an important subject in a plurality of industrial fields. Process safety as well as time and resource efficiency are becoming increasingly important. A special requirement for regular cleaning exists, for example, in the case of:
processing or packaging plants for foodstuff, pharmaceutical products or cosmetics;
drain grates in production plants;
sewage systems;
pipe systems or
tanks (horizontal or vertical)

the inside of which with its surfaces, in particular the surfaces which come into contact with the product, is the application space within the meaning of the invention.

In order to guarantee the necessary cleanliness, technologies are necessary which permit a flexible cleaning as required. State of the Art in cleaning is either manual cleaning or automated CIP (Cleaning in Place) systems with cleaning equipment permanently installed in the application space.

Manual cleaning has the disadvantage that due to its performance by a human operator it is very error-prone and not reproducible.

In the case of CIP cleaning methods, by definition, the plant or part of it is cleaned without it being necessary to disassemble it. By precise definition of cleaning agents, pressures, temperatures and times a reproducible process is determined. Moreover, CIP cleaning systems have high integration cost and their cleaning programmes often operate with determined sequences of cleaning liquids (for example regarding time, composition of the cleaning agents) and operating parameters (for example temperature, operating pressure). Hence, they are rather inflexible and they lack resource efficiency.

Publication WO 2005/083541 A1 describes a piezoelectric debris sensor with associated signal processor. By this means an autonomous or non-autonomous cleaning device equipped with it is enabled to adjust the cleaning process to the determined degree of contamination. A piezoelectric debris sensor can be advantageously used for recognising debris of a specific thickness and which moreover can be directly contacted by the sensor. Therefore, use is only reasonably possible, if such conditions exist.

Publication U.S. Pat. No. 6,026,538 A describes a robot system for duct cleaning in order to remove dirt or dust inside ducts. Movement occurs by recoil, generated by compressed air ejected with adhering dust being simultaneously removed from the surfaces which is then removed by a suction device connected to the duct to be cleaned. The sucked off dust is then conveyed towards the outside into a dust collector through a hose. The robot system is of very simple design and therefore can be used only in a limited way, in particular for simple duct systems.

From US 2008 0173247 A1 a cleaning device equipped with an autonomous function is known which detects the presence of solid animal excrement on a surface and removes it automatically. Detection occurs at a certain distance by means of a camera and infrared sensors but naturally always only on the ground. Further sensors serve for navigation.

Publication DE 10 2004 042 786 A1 describes a device for fully automatic cleaning of a pool where at the back of the robot an optical system for automatic dirt detection is introduced. Dirt detection can occur by electronic image capture of the ground and subsequent analysis by recognition software. The rollers and suction opening are mounted on the underside of the robot. The device can automatically carry out a cleaning operation but only on a surface, the plane, on which it moves. Moreover, the requirement for the cleaning operation is substantially the same everywhere on the flat ground of the pool so that no requirements are made for an adjustment to different conditions.

The subject matter of publication US 2004 0231089 A1 is a cleaning robot provided for cleaning of industrial chimneys. For this purpose, the cleaning robot has a means for own movement and a centrally located rotating brush which during its rotation widens up to the diameter of the pipe to be cleaned, and cleans its surface. Moreover the cleaning robot has a suction device as well as spraying device for the application of cleaning products. Moreover, cameras associated with control means and a lighting means are provided. By said equipment, the cleaning robot is only suitable for being used in a rotationally symmetric pipe with uniform walls at a limited diameter in the area of the maximum achievable brush diameter.

Publication KR 1001 90751 B1 describes an electrically operated cleaning robot provided for the use in channels of an air conditioning system. It has observation cameras connected with a monitor. It moves forward on track chains and is equipped with rotating brushes. The rotating brushes can clean only those surfaces which can directly be reached by them. Moreover no automatic operation is possible.

Moreover, of AWH company a cleaning trolley for tanks is known where a single tank cleaning nozzle on a wheel-supported frame is provided. The frame can, for example, be moved through horizontal tanks in order to be able to clean them across their entire length (https://www.awh.eu/en/products/cleaning-technology/sensors-and-accessories.html). Said solution, however, does not contain any sensor technology for dirt recognition or control options for adjustment of operating parameters for flexible cleaning as required.

### SUMMARY

The invention relates to a cleaning device and a cleaning method for surfaces (22) in an application space (20) comprising at least a removal means (4) for application of a cleaning fluid (7) and/or for the removal of adhesions from the surfaces (22), and at least one positioning means (12) of the cleaning device (1) in the application space (20). According to the invention, the positioning means (12) is connected with a control means (1), which comprises a storage device (1), and with the at least one removal means (4) such that cleaning parameters stored in the storage device of the control means can be assigned to a position, and are transferred by the control means to the removal means (4), and the cleaning parameters, when the position is reached, are applied to the removal means (4).

### DETAILED DESCRIPTION

The systems known from the State of the Art for autonomous or controlled cleaning of surfaces are not suitable for being used in an application space with complicated structure and efficiently clean all surfaces there.

Therefore, it is the object of the invention to offer a cleaning device of simple design for surfaces in an application space which at efficient consumption of resources, in particular cleaning agents, guarantees cleaning with high safety.

The object is achieved by a cleaning device for surfaces in an application space wherein the surfaces below, above and next to the cleaning device can be cleaned, and in particular use within closed industrial plants, which are difficult to access, is provided. The cleaning device comprises at least one removal means for application of a cleaning fluid and/or for removing adhesions from the surfaces, wherein the application of the cleaning fluid and removal of adhesions can be combined by a cleaning jet as is explained in detail below.

At least a positioning means of the cleaning device in the application space is provided which is associated with a control means according to the invention. The connection with the control means, which comprises a storage device and is connected with the at least one removal means, occurs in such a manner that cleaning parameters stored in the storage device of the control means can be assigned to a position. Further control options of the system are included in the invention. Thus, for example, it is provided to derive independently the favourable cleaning parameters from the determined contamination data and the position in space. For this purpose, the respective currently valid interactions between the parameters to be determined from the system (for example position and type of contamination) as well as the parameters to be targeted (for example degree of cleaning) are stored in the system.

In a preferred embodiment of the invention, the cleaning parameters are transmitted by the control means to the removal means, and the cleaning parameters are applied to the removal means when the respective position is attained. The invention includes also a separation in space of control means and/or storage device from the cleaning device including signal transmission between the external control means and/or storage device.

The application space within the meaning of the invention comprises any type and form of a space with not entirely closed spaces being also included. In particular, industrial plants are included here which are otherwise difficult to access for cleaning. Cleaning by means of the device according to the invention is provided for their inner surfaces, which are often of irregular design, comprise undercuts or are not directly accessible mechanically by the position of a conventional cleaning device due to the existing distance.

For cleaning, the cleaning device according to the invention contains several nozzle systems and cleaning units which are controllable individually (for example via valves). By means of said nozzles in combination with independent position detection, depending on the requirement in the different machine areas in the application space, surfaces at varying distances can be cleaned in an efficient way. Thus, it has proven to be advantageous, if the at least one removal means is carried out as a nozzle arrangement, wherein alternatively or in addition use of preferably rotating brushes is provided. The nozzle arrangement applies the cleaning fluid, preferably a liquid, such as, for example, water, also complemented by a chemical and/or mechanical additive which can be realised as granules and preferably under pressure on a site of adhesion by applying the cleaning parameters provided in order to realise a chemical and/or mechanical effect. The cleaning fluid can also be gaseous such as, for example, compressed air. If granules are added, also methods such as powder blasting can be realised.

A preferred embodiment of the nozzle arrangement is realised as one or several stationary nozzles, one or several rotating nozzles and/or as a controlled jet cleaner comprising one or several nozzles controllable in their orientation. The nozzles are each controllable in addition separately by using the cleaning parameters.

As variable cleaning parameters properties of the cleaning fluid, the type of application and/or the direction of the application of the cleaning fluid are provided. As a type of application, parameters such as pressure, temperature and duration of the application are considered as well as intensity, volume flow and/or properties of an aerosol. As changeable properties of the cleaning fluid, for example, the type of fluid, for example, water with a cleaning additive or a gaseous fluid are provided. The cleaning fluid can exist readily prepared or can be variably mixable at the time of application. The amount and/or concentration and also the type of additive can likewise be controlled in that case. For this purpose, the cleaning fluid and the additive are taken from different tanks.

For advantageous positioning
there is according to a first embodiment a manually specified position stored in the storage device related to a distance travelled, determined by a means for calculating the distance driven
according to a second embodiment a detection of local signal transmitters such as, for example, RFID applications or proximity sensors in the application space which, in a particularly preferred embodiment, are also realised in a codable and/or identifiable manner or permit an orientation in any other way, wherein also a combination with the other variants of orientation known from the State of the Art are provided in order to get a fine adjustment for localisation and/or
according to a third embodiment there is provided a spatial form stored in the storage device for control adjustment with data obtained on the position reached by a 3-D scanner. But also CAD data existing from the plant design can be used.

The spatial form stored in the storage device is obtained in the case of a particularly preferred embodiment of the invention during at least an initial movement of the cleaning device through the application space. Hence, the storage device is realised as a self-learning system or as a neural network with methods and algorithms being used which serve to automatically obtain an optimised cleaning result. Moreover, it is advantageous that in that case a complex, preparatory programming can be omitted. Moreover, the cleaning device according to invention can be easily adjusted to new sites as a result.

The invention is a mobile cleaning device which either moves in a self-propelled manner on wheels, on the ground or on a track railway above the ground or it is transported by a conveyor unit. Hence, it can, for example, be transported through the application space, for example, an entire production plant, on an existing conveyor belt, which serves as a conveyor unit, and clean said production plant entirely. Therefore, for movement of the cleaning device to a site in the application space and during the cleaning operation, advantageously a running gear connected with the cleaning device or an adapter for connection with a in particular continuous conveyor are provided in the application space.

Moreover it has proven to be advantageous, if an equipment for the detection of adhesions is provided and connected with the control means. Moreover, it is possible to equip the cleaning device with an optical sensor which searches the environment for contaminated areas. Preferably, the function of said optical sensor is based on a luminescence effect. In this connection, for example, a light spectrum is emitted which in the case of the contamination to be expected (for example bacteria deposit) produces a simple detectable luminescence effect. Alternatively it is also possible to apply an agent onto the surface to be examined which at the lighting provided produces a luminescence effect in interaction with the contamination to be removed. Also, the processing of images at different light spectrums has proven to be advantageous. In this way, when required, only those areas can be cleaned which are contaminated. Moreover, the cleaning progress can be monitored and the cleaning success can be checked.

Therefore, it is particularly convenient, if the device for the detection of adhesions is realised as an optical detector by using a luminescence effect of the adhesion by light radiation emitted by the cleaning device or in the application space. The wavelength can, for example, be outside the visible spectrum and at least partially comprise the UV or IR spectrum.

The device for the detection of adhesions in an alternative embodiment is designed in a manner that NIR or MIR spectroscopy can be executed in a reflection procedure.

In each one of the embodiments the wavelength emitted by the lighting means is matched with the type of adhesion such that a luminescence effect of the adhesion is used. For example, specific bacteria deposits can present a luminescence effect under UV light and can be well detected as a result by means of an optical detector provided by the invention. Above all, the image obtained can be easily evaluated and the result can be entered into a control sequence.

A preferred embodiment comprises a tank connected with the cleaning device which contains the cleaning fluid. The connection between the cleaning device and the tank is provided here as a supply hose for delivery of the cleaning fluid from the outside of the application space. Alternatively or in addition, for example, only for a cleaning additive, an on-board tank is provided which is mechanically connected to the cleaning device.

An advantageous embodiment of the present invention is a suction device and a collecting means connected with the same for cleaning fluid contaminated with the adhesions. Preferably, the collecting means is located outside the application space and connected with the suction device via a supply hose. Alternatively, the on-board collecting means is mechanically connected with the suction device.

Another aspect of the invention concerns a method for cleaning surfaces by using a cleaning device as described above. The position of the cleaning device in an application space is determined here and a control means transmits cleaning parameters as a function of position to a removal means for application of a cleaning agent, in particular the cleaning fluid described above, and for removal of adhesions from the surfaces.

According to one embodiment of the method according to the invention, a detection of adhesions by means of optical detection by the use of a luminescence effect is carried out. The result of the optical detection is evaluated in the control means and implemented in a modification of the cleaning parameters, for example, by repetition of the cleaning operation. In addition, a self-learning system is provided here which provides for permanent modification of the cleaning operation, if insufficient cleaning is detected by the cleaning parameters initially applied.

The method according to the invention for positioning according to a first embodiment provides for a manually specified position stored in a storage device related to a distance travelled. According to a second embodiment, a detection of signal transmitters located in the application space is provided and/or according to a third embodiment a spatial form stored in the storage device is provided for control adjustment with data obtained on the position reached by a 3-D scanner. The spatial form stored in the storage device is preferably obtained during at least an initial movement of the cleaning device through the application space. Also, programming or the use and input of 3-D data already existing is likewise provided.

Another aspect of the present invention concerns use of a cleaning device as it has been described above. The cleaning device is used here in particular in a substantially closed plant and via a current position of the cleaning device a plant part is detected in which the cleaning device is located. A cleaning programme provided for the plant part comprising cleaning parameters as described in detail above is retrieved from a storage device and the cleaning parameters are applied.

In a preferred embodiment, the cleaning device is operated by means of a rechargeable battery and is radio-controlled so that no material electronic interfaces exist. Only for fluid supply, connection to a supply hose is necessary unless an on-board tank exists. The supply hose is preferably connected with an automated hose reel. Automatic winding and unwinding of the supply hose then occurs in a synchronised manner with movement of the cleaning device. Alternatively, however, an entirely self-sufficient solution with one or several fluid reservoirs directly on or in the cleaning device is also provided.

Another alternative is configured such that the drive occurs pneumatically or hydraulically, for example, by means of compressed air. Said embodiment has its advantages, for example, in areas where electric voltage is undesired such as in explosive areas or if compressed air is supplied for other purposes anyway and by the use for driving delivery of another medium can be waived.

Together with a mobile transport station where also the accumulators of the cleaning device can be charged, the device and the hose reel can easily be driven as a compact unit to the different sites and connected there so that a single device can also be used for cleaning several plants.

Advantages of the device according to the invention are in particular higher process safety which represents the most important advantage. This is possible due to monitoring of the cleaning operation and cleaning control by the optical system as well as due to movement of the cleaning system. Said movement results in a particularly advantageous minimisation of spray shadows so that all areas in the application space are safely accessed and cleaned. Advantages are moreover the automatisation of the process (reproducibility) and improved accessibility of hardly accessible areas. Further advantages are moreover the potential for resource saving and the low cost for integration of the system especially since a device can be used for several plants.

### BRIEF DESCRIPTION OF THE DRAWINGS

The following are shown in the accompanying drawings:

FIG. 1 shows an embodiment of a cleaning device 1 according to the invention

### DETAILED DESCRIPTION OF THE PREFERRED EMBODIMENTS

By means of the description of an embodiment and its representation in the associated drawing, the invention is explained in more detail below.

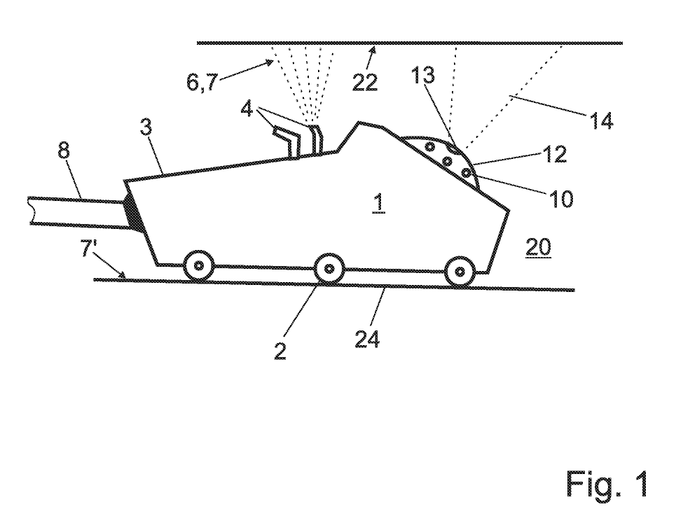

FIG. 1 is a schematic representation of an embodiment of a cleaning device 1 according to the invention. Movement of the cleaning device 1 occurs by driven wheels 2 which are located on a housing 3 and serve as a running gear for independent movement. The wheels 2 are running on a track railway 24 wherein the friction pairing between track railway 24 and wheels 2 is selected in such a manner that a substantially slip-free movement is made possible. Thus, it is also possible to use a means for calculating the distance driven in order to determine and/or verify the current position wherein a non-driven wheel is most appropriate for this.

The main function of the cleaning device 1 is the cleaning of surfaces 22 in an application space 20 by application of a cleaning fluid 7 and/or by removing adhesions. For this purpose nozzles 4 are provided the action of which is provided in all directions where cleaning is required. In the schematic representation, this is shown by a cleaning jet 6 which extends up to the surface 22. The cleaning fluid 7 discharged here is applied to the surface 22 under pressure so that adhesions are removed mechanically. A pretreatment, in particular by using a chemical and/or mechanical additive is provided for soaking the adhesions, if necessary, up to entire removal. In the embodiment shown, the cleaning fluid 7 is supplied from the outside via a supply hose 8 which outside the application space 20 is unwound preferably from a hose reel. Parallel to the supply hose 8, also electrical lines for energy supply and for transmission of information can be lead to the cleaning device 1 according to the invention.

In order to determine the position of the cleaning device 1 in the application space 20, a 3-D scanner 12 is used in the embodiment shown which detects the local three-dimensional structure of the application space 20 and supplies this information to a control means where the additional information is aligned with previously stored information of the known internal structure of the application space 20, and a current position is determined from it. Further information as those gained from the means for calculating the distance driven can be integrated.

An optical detector 13 is provided in order to detect deposits on the surface 22 in an observation area 14, forward the information collected to the control means and thus obtain an adjustment of the cleaning parameters. Since no ambient light is available in a closed application space 20, a lighting 10 is provided which illuminates the observation area 14. The illumination can be made successively or simultaneously in different spectra and/or wavelengths in order to be able to evaluate the different images obtained here. As a result, more precise information on the type of deposits are to be obtained since they have different properties regarding absorption and reflection of different wavelengths of light. By this, in turn, an adjustment and optimisation of the cleaning parameters and a safe and efficient cleaning of the application space 20 can occur. Optimisation can be made not only for the current cleaning cycle but also within the meaning of a self-learning system for general optimisation of later cleaning cycles.

The embodiment shown is particularly suitable for narrow application spaces 20 since it is equipped only with a minimum of additional units and therefore has a small size. If more space is available, for example, an on-board tank for the cleaning fluid 7 can be provided so that the supply hose 8 can be omitted. Also, the energy supply occurs via batteries then. In addition, a tank for contaminated cleaning fluid 7′, for example, collected on the bottom and a suction device can be provided for it.

### LIST OF REFERENCE NUMERALS

1 cleaning device
2 wheel, running gear
3 housing
4 nozzle, nozzle arrangement, removal means
6 cleaning jet
7 cleaning fluid
7′ cleaning fluid contaminated
8 supply hose
10 lighting means
12 3-D scanner, positioning means
13 optical detector, equipment for the detection of adhesions
14 observation area
20 application space
22 surface
24 track railway

1. A cleaning device for at least one surface (22) in an application space (20) comprising at least a removal means (4) for the application of a cleaning fluid (7) and/or for removal of adhesions of the at least one surface (22) and at least a positioning means (12) of the cleaning device (1) in the application space (20), characterised in that the at least one positioning means (12) is connected with a control means (1), which comprises a storage device (1), and with the at least one removal means (4) such that cleaning parameters stored in the storage device of the control means can be assigned to a position, and are transferred by the control means to the removal means (4), and the cleaning parameters, when the position is reached, are applied to the removal means (4).

2. The cleaning device according to claim 1, wherein the at least one removal means (4) is carried out as a nozzle arrangement which applies the cleaning fluid (7) on a site of the adhesion by applying the cleaning parameters.

3. The cleaning device according to claim 2, wherein the nozzle arrangement (4) is carried out as one or several static nozzles (4), one or several rotating nozzles (4), and/or as a controlled jet cleaner, which comprises one or several nozzles (4) controllable in their orientation, wherein the nozzles (4) are each controllable in addition by applying the cleaning parameters.

4. The cleaning device according to claim 1, wherein as cleaning parameters properties of the cleaning fluid (7), type of the application and/or direction of the application of the cleaning fluid (7) are provided.

5. The cleaning device according to claim 1, wherein for movement of the cleaning device (1) to a site in the application space (20) and during the cleaning operation, a running gear (2) connected with the cleaning device (1) or an adapter for connection with a conveyor unit are provided in the application space (20).

6. The cleaning device according to claim 1, wherein an equipment for the detection of adhesions (13) is provided and connected with the control means.

7. The cleaning device according to claim 6, wherein the control means is carried out as a self-learning system for self-optimisation when detecting and treating adhesions.

8. The cleaning device according to claim 6, wherein the equipment for the detection of adhesions is carried out as an optical detector (13) by using a luminescence effect of the adhesion by light radiation emitted by the cleaning device (1) or in the application space (20) by a lighting means (10).

9. The cleaning device according to claim 8, wherein the lighting means (10) is carried in such a manner that NIR or MIR spectroscopy can be executed in a reflection procedure.

10. The cleaning device according to claim 1, wherein the connection between the cleaning device (1) and the tank is provided as a supply hose (8) for delivery of the cleaning fluid (7) from the outside of the application space (20) and/or a tank mechanically connected to the cleaning device (1) which contains at least the cleaning fluid (7).

11. The cleaning device according to claim 1, wherein a suction device and a collecting means is provided for the cleaning fluid (7′) contaminated with the adhesions, wherein the collecting means is located outside the application space (20) and is connected with the suction device by means of a supply hose (8) or the collecting means is an on-board collecting means in the cleaning device (1) and mechanically connected with the suction device.

12. A method for cleaning surfaces by using a cleaning device (1) according to claim 1, characterised in that a position of the cleaning device (1) in an application space is determined and a control means transmits cleaning parameters as a function of position to a removal means (4) for application of a cleaning fluid (4) which is suitable for removal of adhesions from the at least one surface (22).

13. The method according to claim 12, wherein a detection of adhesions is carried, the result is evaluated in the control means and implemented in a modification of the cleaning parameters.

14. The method according to claim 13, wherein the detection of adhesions is carried out by means of optical detection by using a luminescence effect.

15. The method according to claim 13, wherein the control means is a self-learning system and achieves a self-optimisation when detecting and treating adhesions.

16. The method according to claim 12, wherein for positioning according to a first embodiment a manually specified position stored in the storage device related to a distance travelled, according to a second embodiment a detection of signal transmitters located in the application space (20) and/or according to a third embodiment a spatial form stored in the storage device for control adjustment with data obtained on the position reached by a 3-D scanner (12) is provided.

17. The method according to claim 16, wherein the spatial form stored in the storage device is obtained during at least an initial movement of the cleaning device (1) through the application space (20).
